(19) United States
(12) Patent Application Publication
(10) Pub. No.: US 2014/0278280 A1
(43) Pub. Date: Sep. 18, 2014

(54) SYSTEM AND METHOD FOR DESIGNING BUILDINGS

(71) Applicant: Eduardo Pardo-Fernandez, Miami Beach, FL (US)

(72) Inventor: Eduardo Pardo-Fernandez, Miami Beach, FL (US)

(21) Appl. No.: 14/213,865

(22) Filed: Mar. 14, 2014

Related U.S. Application Data
(60) Provisional application No. 61/793,647, filed on Mar. 15, 2013.

(51) Int. Cl. G06F 17/50

(52) U.S. Cl. CPC G06F 17/5004
USPC 703/1

(57) ABSTRACT

A system, a method and a computer program, including an online application software, that enable any user to input the address of a property site at any geographical location worldwide, where the user desires to erect a new building. The system includes a plurality of modules, including modules for residential, commercial and civic buildings in all community types, and through a series of steps guides a user along the process of assessing and determining the allowed buildable envelope, selecting desired building type, building program, construction system, architectural style, and level of environmental responsiveness, as well as intended construction budget. The system analyzes these data and produces building designs that comply with all local, state/provincial and federal/national applicable codes and regulations, embody a rigorous set of architectural, engineering and construction best practices and know-how, related to the specifics of the project, and best respond to the site constraints and user criteria.

### CROSS REFERENCE TO PRIOR APPLICATIONS

This application claims priority under 35 U.S.C. §119(e) to U.S. Provisional Patent Application No. 61/793,647, filed Mar. 15, 2013, titled “SYSTEM AND A METHOD FOR DESIGNING BUILDINGS,” the disclosure of which is hereby expressly incorporated herein by reference in its entirety.

### COPYRIGHT NOTICE

This present application, including Appendices, includes material that is subject to copyright protection. The copyright owner does not object to the facsimile reproduction of the application by any person as the application appears in the records of the U.S. Patent and Trademark Office, but otherwise reserves all rights in the copyright.

### FIELD OF THE DISCLOSURE

The present disclosure relates to a system, a method, and a computer program for providing building designs that comply with all applicable codes and regulations, embody a rigorous set of architectural, engineering and construction best practices and muitidisciplinary know-how, are related to the specifics of a project, and best respond to the project site constraints and user criteria.

### BACKGROUND OF THE DISCLOSURE

As of 2008, more than half of the world population lives in urban areas, and their exponential growth poses increasing environmental, social, and economic challenges in many ways related to place making, compounded by ongoing unsustainable patterns of building design, construction and use.

The last 65 years have witnessed a continuous rise of Sprawl, first started as an exclusively American phenomenon, yet quickly spread throughout the developed and developing world. The massive economies of scale, a penchant for standardization and one-size-fits-all solutions favored by the financial and construction industries, abandonment of traditional wisdom, segregation of land uses, high costs of overdesigned and stretched infrastructure, almost exclusive reliance on energy-intensive systems for human comfort and can-centric mobility, and the disjunction between the private and public realms have brought about the greatest misallocation of capital in human history, evidenced by the loss of agricultural land to a myriad subdivisions and developments, brimming with underperforming, monotonous, aesthetically underwhelming building monocultures, void of the balanced type and use mix found in successful urban settlements. The environmental, economic, social and cultural folly of such practices has been progressively realized over the past three decades, yet never more so than after the Great Recession, and its epic collapse of an American housing market oversaturated with large-tract single-family houses.

Along the way, the architectural profession has saddled the poor with design experimentation, and forced the middle class to choose among mostly bad options, imposed through a skewed free market, as less talented professionals endeavor the highly personal styles of Modern Masters, or the classically inspired ones of Traditionalists, which demand an education and sensibility most practitioners currently lack, thus failing on both accounts. Only the upper class can afford to seek excellence in design, by engaging the very best architects.

The design of new walkable communities, retrofitting of Sprawl, infill revitalization of decaying urban areas, and natural renovation of building stock in existing towns and cities under the dictate of different economic realities, growing demographic pressures and Climate Change, demand new building designs, tailored to a wide range of locale-specific determinants, which can be delivered quickly, affordably, and in a significant quantity to make a difference.

Up until now, arriving at a final set of Construction Documents and Cost Estimate, for any given building, has implied a rather lengthy interaction among users, be it owners, developers or builders, and their architects and engineers, stretching anywhere between a few weeks to several years, one project at a time. This process needs to be made more efficient.

### SUMMARY OF TOE DISCLOSURE

According to some aspects of the disclosure, a computer-implemented method for generating building designs is provided. The method may include collecting by a computer building design data including building specific data and site specific data; generating by the computer at least one building design candidate compatible with the collected building design data; and upon approval of one of said at least one building design candidates, generating by the computer a final set of construction design documents for at least one approved building design candidate.

According to some aspects of the disclosure, the building specific data may comprise one or more of a building type, an architecture type, and an environmental standard. The site specific data may comprises one or more of a site address, zoning description, legal description, and a physical description of the site.

In accordance with aspects of the disclosure, collecting the building design data may comprise gathering by the computer the site specific data; presenting by the computer a selection of building types compatible with the site specific data; upon receipt of a selection of a building type by the computer, presenting a selections of spaces to be included in the building; and determining by the computer a construction system based on the site specific data and the selecting building type. The method may further include presenting a selection of environmental standards.

In accordance with aspects of the invention, generating at least one building design candidate may include generating an array of variables that define a building design based on the building design data.

According to some aspects of the disclosure, the at least one building design candidate comprises one or more of diagrams, pictures, video, and written narrative, the building design candidate describing characteristics of the building and a preliminary cost estimate. The final set of construction design documents for the at least one approved building design comprises working drawings, specifications, and a final cost estimate.

In accordance with aspects of the disclosure, collecting the building design data comprises retrieving data from one or more internal or external databases.

In accordance with some aspects of the disclosure, the method may further include presenting a graphical rendering of the at least one building design candidate. The graphical rendering comprises a virtual tour of the at least one building design. The graphical rendering may illustrate the at least one design candidate within in the context of the surrounding neighborhood.

According to some aspects of the disclosure, site specific data may comprise zoning data, and wherein collecting the site specific data comprises searching a database for a zoning ordinance applicable to the site, wherein when a zoning ordinance cannot be located, a zoning questionnaire is presented to a user to obtain zoning information.

In accordance with some aspects of the disclosure generating the at least one building design candidate may comprise searching at least one database of building designs for one or more building design candidates compatible with the building design data. For each building design candidate, an estimated construction cost may be computed.

According to some aspects of the disclosure, the method may also include receiving a request to edit at least one component of the design after presenting the graphical rendering; and generating a new graphical rendering reflecting the requested edit. The graphical rendering illustrates the at least one design candidate within the context of the surrounding neighborhood.

According to some aspects of the disclosure, a building design system for generating building designs is provided. The system may include a building design data collector unit that collects building design data including building specific data and site specific data; a building design determiner unit that identifies at least one building design candidate compatible with the collected building design data; and a building design generator unit that, upon approval of one of said at least one building design candidates by the building design determiner, generates a final set of construction design documents for the at least one approved, building design candidate.

The building design collector may be configured to gather site specific data; present a selection of building types compatible with the site specific data; upon receipt of a selection of a building type, present a selections of spaces to be included in the building; and determine a construction system based on the site specific data and the selected building type. The system may also include an environmental standards presenter unit that presents a selection of environmental standards.

Additional features, advantages, and embodiments of the disclosure may be set forth or apparent from consideration of the detailed description, drawings and attachment. Moreover, it is to be understood that the foregoing summary of the disclosure and the following detailed description, drawings and attachment are exemplary and intended to provide further explanation without limiting the scope of the disclosure as claimed.

### BRIEF DESCRIPTION OF THE DRAWINGS AND APPENDICES

The accompanying drawings, which are included to provide a further understanding of the disclosure, are incorporated in and constitute a part of this specification, illustrate embodiments of the disclosure and together with the detailed description and attachment serve to explain the principles of the disclosure. No attempt is made to show structural details of the disclosure in more detail than may be necessary for a fundamental understanding of the disclosure and the various ways in which it may be practiced. In the drawings:

FIG. 1 shows a high-level diagram describing an example of a system according to the principles of the disclosure;

FIG. 2 shows an example of a suite of workflow components, according to an embodiment of the disclosure

FIG. 3 shows a flow diagram summarizing and illustrating a building design selection method, according to the principles of the disclosure;

FIGS. 4A-4E show further details of the method shown in FIG. 3; and

FIGS. 5A-5G show detailed views of portions of a buildable envelope determination process;

Appendices A-C show examples of a Zoning questionnaire, Site questionnaire and Context questionnaire, respectively, illustrating metrics, analysis and logic associated with the building design selection method, according to the principles of the disclosure; and

Appendix D shows an example of a set of formulae and tables used to process information that may be implemented in the building design selection method.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments, as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

FIG. 1 shows an example of a system 100, which is constructed according to the principles of the disclosure. The system 100 includes a computer (or user computer) 110, a server (or server computer) 120, and a network 150. The system 100 may include an internal database 130 and/or an external database 140. The databases 130/140 may be located at or in the server 120, or remotely from the server. The system 100 may be interconnected through one or more communication links. In the system 100, at least one user, and at least one server, may communicate with at least one integrated analysis and design environment that can reside, in part or in full, in the network 150, which may include a cloud application, the user computer 110, the server 120, or any combination thereof. The cloud application may collect information from the user via the user's computer interface, and pull data, from either internal database(s) 130 residing in at least one server, external database(s) 140, or any combination thereof, which may then be processed, analyzed, arranged and customized to produce a final output.

FIG. 2 shows an example of a suite of workflow components, according to an embodiment of the disclosure. The high-level block diagram illustrated in FIG. 2 illustrates interrelated applications and modules within the system online software platform. The suite of workflow components may include, for example, a system platform 200 and a suite of applications or modules, including, e.g., a residential module 210, a commercial module 220, a civic module 230, a real estate and value calculator module 240, a construction financing module 250, and the like. The system platform 200 and the modules 210-250 may reside in the network 150 (shown in FIG. 1), which may include a computer cloud, or the server 120, and/or the user computer 110. The suite of workflow components may further include an interface to communicate with the system members' community 260, an allied professional network 270, and allied partner companies 280.

FIG. 3 shows an example of a building design selection method, according to an embodiment of the disclosure. Phase I 300 of the method comprises obtaining, determining, and/or collecting all data necessary to select building designs. At 302, information is gathered about any specific building site, including its address, zoning data, legal and physical descriptions, and relevant context. At 304, the user is requested to select the desired building type, out of a limited range resulting from the analysis of site data. At 306, the building program is defined, including quantitative and qualitative parameters, as well as functional relations. At 308, the construction system to be used is defined, out of those options determined by a logic analysis automatically performed on site data. These options are also compatible with and optimized for the building type selected. At 310, the fundamental decision of architectural style is made between Modern versus Traditional, as allowed by the architectural regulations in place, and further defined. At 312, the desired level of environmental response is selected, with a default option offered as the most basic, also built into all other ones. Increasing levels of compliance characterize subsequent options, comparable with the USGBC Silver, Gold and Platinum LEED certification levels. At 314, automatic analysis of all metrics obtained or determined at steps 302, 304, 306, 308, 310 and 312 is performed to produce a specific array of variables, used next to select building designs and generate a population within the system. It should be noted that some metrics associated with any given building site can be derived directly from the input data, while other metrics are derived from simulated or calculated results, or from interior or exterior databases, the search of which is triggered by data input. At 316 the expected construction budget is obtained.

Phase II 320 starts at 322, where the building designs population is organized in an array, according to overall compatibility with the metrics obtained or determined at steps 302, 304, 306, 308, 310, 312 and 316. At 324, the building designs are unveiled, as portrayed on the user interface by visual communication devices, such as plans, diagrams, pictures and/or video, written communication in the form of a plain language narrative, and tabular information; thus describing the design intent, preliminary cost estimate, and other relevant characteristics of the building designs. Comparison of all building designs unveiled can take place at this point, as well as final selection of the desired one.

Phase III 330 allows the user to confirm the suggested selection of building materials, products and finishes generated for the finally chosen building design, or otherwise customize them 332. At the end 340 a complete set of construction documents including, but not limited to, working drawings and specifications, and a final construction cost estimate, are generated.

Referring now to FIGS. 4A through 4E, a more detailed description of a succession of steps through which the system may direct a user, allow data input, and trigger actions, some of which may be rather complex, that later change subsequent items in the workflow is provided. The workflow step items are meant to provide immediate and direct guidance to the user, e.g., as part of the interface, supplying illustrated definitions and support metrics as necessary, and directly linking to specific databases and help resources. Workflow item completion can unlock later actions for use, which can be carried out sequentially and or in parallel, requesting, processing or providing information. By having the user submit a valid e-mail address at the beginning of the workflow, the user session provides the capability to track all workflow items, and allow the user to stop and retake the building design selection process at any point within the workflow, in case the user might need to collect some requested information for input, or further ponder any decision. At the end of the workflow navigation the expected result is generated, with the stated benefits.

In FIGS. 4A-4E, the workflow navigator starts 401 by, e.g., requiring the user to register through a valid e-mail address, and then requesting the full address 402 for the site where the user desires to erect a building, including city or town name, as well as that of the state, province or department, and the zip or postal code. This triggers Step 1 of Phase I, where all relevant site information is gathered. According to the preferred embodiment, the system searches 403 within a zoning database 494 for the specific zoning ordinance enforced at the site location. In accordance with some aspects of the disclosure, the zoning database 404 may be an internal database storing known zoning ordinances for one or more jurisdictions. In other aspects, the zoning database 404 may include one or more external databases accessible over a communication network. Once an appropriate zoning ordinance is determined, confirmation of the zoning ordinance may be requested from the user 405. After a correct match the system also searches for the Zoning District/Transect Zone 406 by pairing the address with the Zoning District/Transect Zone labeling of each property, within the local Tax Folio, Zoning Map, Regulating Plan and/or other database(s) 407. Confirmation of a correct Zoning District/Transect Zone identification 408 allows the system to pull out ail the necessary standards and parameters regulating density, intensity and all other zoning constraints 409 for the site.

If the Zoning Ordinance identified at 403 is deemed incorrect by the user at 405, or if no match is found at 403, then the System allows the user to carry a name search 410 within zoning database 404, which could overcome a small name difference behind the unsuccessful attempt at identifying the corresponding Zoning Ordinance. If the Zoning District/Transect Zone identification at 408 is incorrect or yields no result, the System allows the user to input the name of the Zoning District/Transect Zone manually, triggering a name search 411 within the internal Zoning Database 404.

If name searches 410, 411 still yield no correct identification for the Zoning Ordinance and Zoning District/Transect Zone, the system assists the user to fill in the zoning questionnaire 412, thus obtaining zoning constraints 409 for the Site.

The system pulls the legal Description corresponding to the Site address by searching 413 within the local Tax Folio, Zoning Map, Regulating Plan and/or other database(s) 407. If no match is achieved, then the user is directed to input the legal description manually 414. The legal description 415 defines the site location and boundaries, may be included in working drawings, and allows for a graphic rendition of the site if necessary.

According to some aspects of the disclosure, the system pulls the corresponding property lines, topography, geotechnical data, and other relevant multilayered information 416 from local/national GIS mapping database(s) 417, by using the site address. An exact rendition of the site is thus graphically generated 418, the topography of which is checked against a topographical database 419. The system then assists the user to fill in the site questionnaire 420, which allows for confirmation and further input of geographical data and other relevant physical information, thus arriving to a detailed summary of the site physical description/constraints 421.

If GIS mapping is not available for the site location, the system may query the user to upload a scan of the property survey for the site, and input specific information from, for example, a Certificate of Elevation and/or the geotechnical report 422. The system then applies computer vision capabilities to process and interpret the scanned image, which together with the legal description 415 allows for an exact rendition of the site to be graphically generated 418, the topography of which is obtained from the topographical database 419. The user is thereon directed to the site questionnaire 420, and ultimately to a detailed summary of the site physical description/constraints 421.

If the user has a property survey hardcopy, but no scanning capabilities, the system can assist the user to manually input the metes and bounds 423 for the site, if applicable, which together with the legal description 415 allows for an exact rendition of the site to be graphically generated 418, the topography of which is obtained from the topographical database 419. The user is thereon directed to the site questionnaire 420, and ultimately to a detailed summary of the site physical description/constraints 421.

If the user has no property survey whatsoever, the system may direct him to those land surveyors who are members of the system's Allied Professional Network 425, therefore vetted as acknowledged, trustworthy professionals, and available in the area, who the user could approach to get a property survey and Elevation Certificate from 424.

The system searches for relevant context information 426 within, the internal Context Database 427 and local/national GIS mapping database(s) 417. The user is then assisted to fill the site context questionnaire 428, to confirm/retrieve all information pertaining to the immediate neighboring properties to the site, as well as the surrounding urban patterns and other related data, thus performing a detailed context analysis 429.

The determined zoning constraints 409, legal description 415, rendered site with physical description/constraints 421, and context analysis 429 are processed, mashed up, and modeled to provide the buildable envelope 430 for the site, where all those criteria and metrics are embodied. This ends Step 1 of Phase I.

In Step 2 of Phase I the system's workflow navigator directs the user to select a building type. The system may automatically search for those basic (primary) building types that are allowed within the corresponding Zoning District/Transect Zone, presenting them to the user for selection 431, along with a brief written and graphically illustrated definition for each, to better inform the decision. The selection process may be taken one step further as the system identifies the specific (secondary) building types within the previously selected basic (primary) building type category, which are compatible with the local cultural building tradition, and geared to deal with the local climate and social trends and customs in the most successful manner, thus presenting them to the user for selection 432, along with a brief written and graphically illustrated definition for each, to better inform the decision. As a result, a very concrete, locally tailored building type 433 may be selected for the project.

In Step 3 of Phase I the system's workflow navigator may direct the user to select rooms/spaces 434 to be included in the building program. Quantitative 435 and Qualitative 436 choices are available. Quantitative options offered to the user deal with parametric variables, to be fixed at a given value; e.g., in the residential module, the system requests the user to choose the desired number of bedrooms, baths, etc. Qualitative options offered to the user include other rooms/spaces that bring value not by the number, but by its mere inclusion or exclusion, e.g. a swimming Pool. Rooms/Spaces grouping 437 allows the user to choose among specific space arrangements and adjacencies offered, which make sense given the quantitative and qualitative choices just made. The system presents the user with major appliance and fixture categories 438 for selection, so they and their count can be included in the planning of functional areas (though specific product selections take place in Phase III), and with a list of verbalized subjective values to choose from 439 e.g. well-lit, solid, airy, open-concept, which are household terms in the real estate and design worlds, and that once selected bring forward specific building designs which also embody most or ail of those values. The quantitative 435 and qualitative choices 436, room/space grouping 437, major appliance/fixtures categories selection and count 438, and subjective values selection 439 metrics are then summarized by the system in the building program 440.

In Step 4 of Phase I the system's workflow navigator determines and presents the user with different choices of locally feasible and most commonly used building systems for selection 441. Each one of the presented options is accompanied by a locally calibrated approximate index of cost construction per area unit, put together with information pulled out from local/national construction costs database(s) 442, as well as a brief written and graphically illustrated definition, with the building system pros and cons, to better inform the decision. Locally fitting proprietary systems belonging to Allied Partner Companies 443 are also featured as possible options. Building system options can be overridden by the user, searching for options other than those optimal ones initially brought forward by the system's workflow navigator. Using the geotechnical/soil information requested/determined as part of tire site physical description/constraints 421, the system recommends foundation systems which are safe, compatible with the just chosen building system, and locally feasible, presenting them to the user for confirmation/selection 444, along with a brief written and graphically illustrated definition for each, and a locally calibrated approximate index of cost construction per area unit, put together with information pulled out from local/national Construction Costs and Allied Partner Companies database(s) 442, 443, to better inform the decision. A specific construction system 445 is thus determined for the project.

In Step 5 of Phase I the system's workflow navigator requests selection of architectural style 446, as allowed by the zoning ordinance in place, including architectural standards. As a brief audiovisual/written/graphic conceptual introduction is generated, the fundamental choice between modem 447 and traditional 448 architectural styles may be explained, and locally relevant examples of both illustrated. If the traditional option is selected, the system may identify whether very defined and strong stylistic precedents characterize the local building culture, by searching within Its internal traditional styles database 449, and may request the user to choose among fitting historical building styles that are still or should be part of the local living building tradition 450. All traditional building designs are gauged along the Classical/Vernacular spectrum, and allocated accordingly. The architectural style is determined for the Building 451.

In Step 6 of Phase I the system's workflow navigator presents choices for the level of environmental response 452 the user desires to accomplish for the building design. The Original Green 453 is the most basic, yet the most significant. It aims to achieve buildings that can engage the community, be capable of playing a role in the production of food and water for their occupants, be accessible, appropriate to its location and cultural heritage, flexible, durable, frugal and responsive to the local climate by default, through the use of time-tested traditional techniques. This level is also present as the minimum required for the materials and products placed in the Architect's Choice material, product or finish selection suggested for the Specifications, in Step 1 of Phase III. Silver Green 454, Gold Green 455, and Platinum Green 456 have the Original Green 453 level requirements embodied. In addition to them, they also include several possible combinations of design features that, when checked against the USGBC LEED Certification checklist(s), account for the comparable number of certification points required for corresponding LEED Certification levels. By including any of those combinations of design features, the selected level of Environmental Response makes the Building Design LEED-certifiable. In all cases, the most important implications of each level selection are explained through a brief written and graphically illustrated definition, along with comparative metrics, to better inform the decision. A conscious selection of the desired level of environmental response 457 for the project is therefore made.

At this point the system's workflow navigator may perform a thorough analysis of the buildable envelope 430, building type 433, building program 440, construction system 445, architectural style 451, and level of environmental response 457 metrics, create a specific array of variables, searched within its internal building designs database 459 for those building designs that match said variables with varying degrees of compatibility, within a permissible range, and generate a finite population of building designs with preliminary construction cost estimates 458. The population may be divided into ranges according to their construction cost.

If by any chance the population of building designs with preliminary construction cost estimates cannot be generated 458, due to building program 440 requirements which do not physically fit within the buildable envelope 430 of the site, the system's workflow directs user to jump backwards in the workflow to Step 3 of Phase I, and come up with a more modest building program 440, which could then be used to generate a valid population of building designs with preliminary construction cost estimates 458.

In Step 7 of Phase I the system's workflow navigator may prompt the user to provide a construction budget for the project 460, after providing the user with a brief audiovisual/written/graphic introduction explaining construction costs, how they fit within the larger project budget, and what other expenses are applicable and reasonable to expect. If the user already has a construction budget in mind, there is an option where said figure can be input directly 461, and then allocated within the corresponding construction cost range 462, out of those into which the building designs population has been divided. If, on the contrary, the user has no budget set yet, there is another option where the system presents the building design population's construction cost ranges to choose from 463. In either option, the resulting selection determines the desired construction budget 464.

If the construction budget figure entered by the user in the first scenario is lower than the presented construction cost ranges within the building designs population, or if those are deemed too high by the user, when confronted with them for selection under the second scenario, the system's workflow navigator presents the user with path options 465: move forward to Step 1 of Phase II, and unveil building designs for evaluation and selection regardless, in which case the lower construction cost range would be selected by default; go back and input/select a higher construction budget/range; or otherwise jump backwards in the workflow and modify metrics that affect costs, following specific construction cost-reducing suggestions by the system; thus triggering the generation of a new population of building designs with lower preliminary construction cost estimates 458, winch may then be divided again into ranges according to their construction cost.

After identifying the targeted construction budget 464, the system's algorithm adds this metric to all other ones used to generate the building designs population 458, and proceeds to filter, discriminate and arrange building designs, with their preliminary construction estimates, according to relevance 466.

In Step 1 of Phase II, the system's workflow navigator unveils proposed building designs 467, retrieving, for example, the three single-most relevant ones out of the population. Each building design is displayed on the user interface by means of visual communication devices, plain language narrative, and tabular information including, but not limited to, a 3D animation and/or artistic rendering(s), presentation site and floor plan(s), preliminary construction cost estimate, design intent narrative, spatial parameters summary, LEED-“certifiability” level, approximate energy cost projections, and search relevance Index. The user can either retrieve the rest of the diminishingly relevant building designs out of the population for evaluation, for example, in groups of three 468, and single out any combination of building designs for simultaneous comparison 469, prior to making a final building design selection 470, or jump forward in the workflow and make a final building design selection 470 out of the three first building design options. The system's workflow navigator then presents the user with small spatial variables for selection 471, in those building designs where they are available.

If the user decides to make changes to the variables determined in Steps 2 through 7 of Phase I, after evaluating the building designs, the system's workflow allows the user to jump backwards at will 472, while also keeping one or more of the building designs originally unveiled, for further comparison, and confirm or modify all other determined metrics, which would then be analyzed and generate a new population of building designs to choose from, with preliminary construction cost estimates.

After the Final Building Design selection, the system's workflow directs the user to Step 1 of Phase III, where the preliminary selection of all building materials, products and finishes involved is confirmed or modified 473; thus effectively customizing the set of specifications to be included in the construction documents.

According to the preferred embodiment, the user may take a virtual tour of the finally selected building design. As the user moves through virtual rooms and spaces, all relevant categories of construction materials, products and finishes are sequentially brought up for selection, and the available options found and retrieved from local/national Construction Costs and Allied Partner Companies database(s) 442, 443, and then presented by means of visual communication devices, plain language narratives, and tabular information. As the user evaluates each option, it is rendered inside the virtual model of the room or space for which the selection is being made, and both a locally gauged Cost Index reflecting how it affects the Construction Budget allowance for that given category, and a brief pros/cons Narrative are generated; as well as a Tabulation of certain metrics, the logical analysis of which can better inform the decision.

Only a finite number of options are made available by the system at any given time, since all of them must be compatible with the design intent of the finally chosen building design. For each category, there may be multiple different options to be evaluated by the user. The options may include, for example, an architect's choice 474, an economical choice 475, and a greener choice 476. Additional and/or different choices may also be presented.

The Architect's Choice 474 may be the option that best matches the design intent, Construction Budget, and overall user preferences, as reflected in the determined metrics resulting from Steps 2 through 6 of Phase I. The Economical Choice 475 offers the most affordable option within any given category finite universal set. The Greener Choice 476 is the most ecologically sensitive option available for any given category. It offers an upgrade for a specific product or material in terms of Environmental Response, beyond the particular level determined in Step 6 of Phase I. In addition to all the data provided with every option, an indicator of Carbon Footprint and LEED rating points achievable by that choice are included, to better inform the decision.

Besides the Architect's, Economical and Greener Choices, the user may be provided with an “Other Choices” 477 option, where additional options within a permissible range of compatibility with the design intent are generated for evaluation, varying in price point. The user has the option to override all offered choices for some categories, and directly input a material, manufacturer or product of the user's preference. Preset interior design packages can also be chosen for the finally selected building design. Once the virtual tour is finished, and selections made for all materials, products and finishes categories, the system's workflow navigator presents their summary for confirmation 478.

If the user decides to revisit any given selection, or finds out that some choices might have pushed the construction budget above acceptable limits, the System's workflow navigator allows the user to jump backwards in the workflow 479, re-entering virtual rooms or spaces for evaluation, rendering and selection of new choices.

After confirmation of all construction materials, products and selections, a complete set of Construction Documents including, but not limited to, Working Drawings and Specifications, and a final Construction Cost Estimate, are generated as the final output 480.

FIGS. 5A through 5G shows an example of a buildable envelope determination process that may be implemented in the building design selection method of FIGS. 3 and 4. FIGS. 5A through 5G loosely illustrates the processes that take place within Step 1 of PHASE I of the System's cloud application workflow navigator, in any of the modules illustrated in FIG. 2, as well as any other module that might be created hereafter.

As shown in FIG. 5A, a site plan 510 may be generated representing the zoning constraints and legal description of the site obtained in Phase I of the building design process. The site plan 510 may illustrate any placement constraints for placing, for example, a main building 512 or an outbuilding 514 on the site lot 516.

FIG. 5B illustrates the retrieval of the site topography 518, and the rendering of the site topography is shown in FIG. 5C. FIG. 5D illustrates a rendering of the physical description and any constraints associated with the site. For example, as shown in FIG. 5D, a tree 520 to be considered when placing a building is shown. Sun exposure 522 is also illustrated as well as utility access points 524. Any other constraints may also be illustrated, allowing a user to easily see how placement of a building fits the underlying topography of a site.

As described above, in order to construct a building that fits the existing style of the neighborhood, context analysis may be performed relative to buildings or structures surrounding a planned site. As shown in FIG. 5E, the buildings surrounding a planned side may be rendered along with a proposed building.

As shown in FIG. 5F, the generated building envelope may be rendered along with the surrounding buildings. As shown in FIG. 5G, a building design is shown along with the surrounding buildings. As described above, multiple building design options may be generated. The system allows a user to view each prospective design and how the finished design fits in the site.

As described above, various questionnaires may be presented to a user to aid in generating a building design. For example, a zoning questionnaire may be provided to a user when zoning information describing the site cannot otherwise be obtained, or where the obtained information can be further supplemented by gathering user input. The zoning questionnaire may be configured to obtain specific parameters and ranges that may be used to generate the zoning constraints of the site with enough precision to enable testing of building designs. The zoning questionnaire may ask the user to provide a zoning district and/or transect zone associated with a site. The user may also be asked to define a plurality of variables associated with a site such as, for example, a lot area, building floor area, building height, principle building elevation, and/or other site-related variables.

The user may also be asked questions related to the functional use of the building to be placed on the site. Questions may include, for example, questions related to a type of building (e.g., residential, commercial, civic, etc.). The zoning questionnaire may also include questions related to the proposed building's disposition on the lot, such as the lot occupancy, building setbacks, distance between main building and any outbuildings, etc. The questionnaire may also seek to obtain building configuration information, such as information about building enclosures, heights, openings, encroachments, street screens, etc. Any architectural standards associated with the zone in which the site is located may also be obtained via the questionnaire. Such information may include any restrictions or requirements related to, for example, roof standards, building wall materials, arcades, porches/balconies, fences/walls/hedges, awnings/canopies, chimneys, gutters/downspouts, swimming pools, greenhouses, colors, etc. The questionnaire may also present questions related to any parking calculations and standards, loading standards, landscape standards, sustainability standards, and/or other zoning related information. An example of a detailed zoning questionnaire that may be presented in shown in Appendix A.

A site questionnaire may also be presented to obtain additional site descriptive information from a user. The site questionnaire may be configured to collect geographical and other relevant data to generate a tridimensional and precise site rendition and building envelope, with enough precision to enable testing of building designs. For example, the site questionnaire may ask a user to confirm information obtained from various databases and to provide some additional descriptive information. The site questionnaire may request a description of the land including, for example, lot classifications (e.g., lot type, parking access, etc), survey data (e.g., orientation, boundaries, reference points, easements, thoroughfares, utilities, existing structures, etc.), geotechnical data (e.g., soil description, bearing capacity, percolation rate, water table depth, frost line depth, etc.) environmental data (e.g., hydrology, natural features, flora, fauna, views, noise, etc.), and/or any other sited related data. An example of a site questionnaire is shown in Appendix B.

To obtain information about the area/neighborhood surrounding a building site, a contextual questionnaire may be presented. The contextual questionnaire may be configured to collect relevant information about the immediate urban context surrounding the site, collected in order to better match and arrange building designs within the compatible population generated. The contextual questionnaire may be request information about, for example, public transportation, joint use easements, adjacent lots, and/or any other data that might be useful in obtaining a contextual view of the area/neighborhood encompassing a proposed building site. An example of a contextual questionnaire is shown in Appendix C.

Using the information obtained via database access as well as user questionnaires, the system is able to perform a plurality of calculations to be used in creating a population of building designs that meet the proposed constraints. For example, the precise zoning constraints may be used to evaluate individual building designs in order to include them or not into the population generated. Similar sets of formulae and tables could be employed to further evaluate individual building designs based on other site and contextual information. One enabling example of a set of formulae and tables used to process and analyze zoning information collected is shown in Appendix D.

As detailed in Appendix D, information obtained from the zoning database and/or zoning questionnaires may be used to evaluate whether a proposed design is an appropriate candidate. The determination and analysis of the zoning constraints may use Boolean Algebra logic, according to which the values of the variables are the truth values “true” and “false”, identified or represented as “1” and “0” respectively, which should not be confused with the integers 1 and 0. This logical analysis performs the basic operations of logical conjunction and logical disjunction, as well reflexive relations including “is equal to”, “is greater than or equal to” and “is less than or equal to”. Thus, for each perspective design, a plurality of variables, as described herein, are evaluated against the zoning constraints to determine whether the design can be included as a viable design option.

According to an aspect of the disclosure, a computer readable medium is provided containing a computer program, which when executed on, for example, the server 120 (shown in FIG. 1), the user computer 110 (shown in FIG. 1), or the network 150 (shown in FIG. 1), causes the process shown in FIGS. 3 and 4 to be carried out. The computer program may be tangibly embodied in the computer readable medium, comprising a code segment or code section for each of the steps in FIG. 3 and 4.

A “computer,” as used in this disclosure, means any machine, device, circuit, component, or module, or any system, of machines, devices, circuits, components. modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, a cloud computer, or the like, or an array of processors, microprocessors, central processing units, general purpose computers, super computers, personal computers, laptop computers, palmtop computers, notebook computers, desktop computers, workstation computers, servers, or the like.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any of its computers, may also be used as a workstation.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link,” as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, Wi-Fi, Wi-MAX, IEEE 802.11, DECT, 0G, 1G, 2G, 3G or 4G cellular standards, Bluetooth, and the like.

A “network” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, a network cloud, or the like, or any combination of the foregoing, any of which may be configured to communicate data, via a wireless and/or a wired communication medium.

The terms “including,” “comprising,” and variations thereof, as used in this disclosure, mean “including, but not limited to,” unless expressly specified otherwise.

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices, which are not explicitly described as having such functionality or features.

A “computer-readable medium,” as used in this disclosure, means any medium that participates in providing data (for example, instructions), which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, Wi-Fi, Wi-MAX, IEEE 802.11, DECT, 0G, 1G, 2G, 3G or 4G cellular standards, Bluetooth, or the like.

While the disclosure has been described in terms of exemplary embodiments, those skilled in the art will recognize that die disclosure can be practiced with modifications in the spirit and scope of the appended claims. These examples are merely illustrative and are not meant to be an exhaustive list of all possible designs, embodiments, applications or modifications of the disclosure.

What is claimed:

1. A computer-implemented method for generating building designs, comprising:
collecting by a computer building design data including building specific data and site specific data;
generating by the computer at least one building design candidate compatible with the collected building design data; and
upon approval of one of said at least one building design candidates, generating by the computer a final set of construction documents for it.

2. The method of claim 1, wherein the building specific data comprises one or more of a building type, an architecture type and/or style, a construction system, a construction budget range, and an environmental response standard.

3. The method of claim 1, wherein the site specific data comprises one or more of a site address, zoning description, legal description, and a physical description of the site.

4. The method of claim 1, wherein collecting the building design data comprises:
gathering by the computer the site specific data;
presenting by the computer a selection of building types compatible with the site specific data;
upon receipt of a selection of a building type by the computer, presenting a selections of spaces to be included in the building; and
determining by the computer a construction system based on the site specific data and the selecting building type.
presenting by the computer a selection of architectural styles compatible with the building and site specific data:

5. The method of claim 4, further comprising, presenting a selection of environmental standards.

6. The method of claim 1, wherein generating at least one building design candidate comprises:
generating an array of variables that define a building design based on the building design data.

7. The method of claim 1, wherein the at least one building design candidate comprises one or more of diagrams, pictures, video, and written narrative, the building design candidate describing characteristics of the building and a preliminary cost estimate.

8. The method of claim 1, wherein the final construction documents set comprises working drawings, specifications, and a final cost estimate.

9. The method of claim 1, wherein collecting the building design data comprises retrieving data from one or more internal or external databases.

10. The method of claim 1, further comprising:
presenting a graphical rendering of the at least one building design candidate.

11. The method of claim 10, wherein the graphical rendering comprises a virtual tour of the at least one building design.

12. The method of claim 10, wherein the graphical rendering illustrates the at least one design candidate within in the context of the surrounding neighborhood.

13. The method of claim 1, wherein the site specific data comprises zoning data, and wherein collecting the site specific data comprises searching a database for a zoning ordinance applicable to the site,
wherein when a zoning ordinance cannot be located, a zoning questionnaire is presented to a user to obtain zoning information.

14. The method of claim 1, wherein generating the at least one building design candidate comprises:
searching at least one database of building designs for one or more building design candidates compatible with the building design data.

15. The method of claim 14, further comprising, for each building design candidate, computing an estimated construction cost.

16. The method of claim 10, further comprising:
receiving a request to edit at least one component of the design after presenting the graphical rendering; and
generating a new graphical rendering reflecting the requested edit.

17. The method of claim 10, wherein the graphical rendering illustrates the at least one design candidate within the context of the surrounding neighborhood.

18. A building design system for generating building designs, the system comprising:
a building design data collector unit that collects building design data including building specific data and site specific data;
a building design determiner unit that identifies at least one building design candidate compatible with the collected building design data; and
a building design generator unit that, upon approval of one of said at least one building design candidates by the building design determiner, generates a final set of construction documents for the design.

19. The system of claim 18, wherein the building design collector is configured to:
gather site specific data;
present a selection of building types compatible with the site specific data;
upon receipt of a selection of a building type, present a selections of spaces to be included in the building; and
determine a construction system based on the site specific data and the selected building type.
identify and present a selection of architectural styles among which to choose the one to be featured in the building.

20. The system of claim 18, further comprising:
an environmental standards presenter unit that presents a selection of environmental standards.
